(19) United States
(12) Patent Application Publication
(10) Pub. No.: US 2010/0109535 A1
(43) Pub. Date: May 6, 2010

(54) LIGHT-EMITTING DEVICE

(76) Inventor: Chung-Jyh Lin, Tainan County (TW)

Correspondence Address: BIRCH STEWART KOLASCH & BIRCH, PO BOX 747, FALLS CHURCH, VA, 22040-0747, US

(21) Appl. No.: 12/612,715

(22) Filed: Nov. 5, 2009

(30) Foreign Application Priority Data
Nov. 6, 2008 (TW) 097142959
Apr. 14, 2009 (TW) 098112376

(51) Int. Cl. H05B 37/02

(52) U.S. Cl. 315/149; 315/185 R

(57) ABSTRACT

A light-emitting device includes a light-emitting diode (LED) module, a detecting circuit and a control circuit. The light-emitting diode module receives a variable voltage. The detecting circuit detects a light state of the light-emitting diode module and then outputs a control signal. The control circuit is electrically connected to the light-emitting diode module and adjusts the amount and/or the light state of the on-state light-emitting diodes in the light-emitting diode module in accordance with the control signal.

### CROSS REFERENCE TO RELATED APPLICATIONS

This Non-provisional application claims priority under 35 U.S.C. §119(a) on Patent Application No(s). 097142959 and 098112376 filed in Republic of China on Nov. 6, 2008 and Apr. 14, 2009, the entire contents of which are hereby incorporated by reference.

### BACKGROUND OF THE INVENTION

1. Field of Invention

The present invention relates to a light-emitting device.

2. Related Art

Light-emitting diode (LED) is one of semiconductor elements. In the beginning, most of light-emitting diodes were used as indicator lights and light sources for outdoor display boards. Due to the advantages of high luminous power, long lifetime, and breakage-resistance, which conventional light sources barely have, light-emitting diode is praised as the innovative type of light source in the 21st century.

Generally speaking, the control methods of devices using light-emitting diodes as a light source can be classified into two types: constant voltage control and constant current control. As shown in FIG. 1A, the conventional light-emitting device 1A, controlled by constant voltage, includes a light-emitting diode module 11, a capacitor 12, a plurality of resistors 13 and a constant voltage source 14. For the constancy of voltage signals inputted into light-emitting diodes, designers usually have to use capacitors with high capacitance values or more complicated rectification circuits to stabilize the voltage; however, it increases the production cost.

Although the circuit of constant voltage control is easier to design, the constant voltage control cannot provide a stable current. Light-emitting diodes depend on the combination of electrons and holes to release excess energy in the form of light so as to achieve luminant effect. However, current variation imposes a great influence on the illuminating properties of light-emitting diodes. In other words, the constant voltage control cannot accurately control the illuminating properties of light-emitting diodes.

In contrast, as shown in FIG. 1B, another conventional light-emitting device 1B controlled by constant current includes a light-emitting diode module 11, a capacitor 12, a plurality of resistors 13, a constant current source 15 and a detecting unit 16. Although the constant current control can provide a stable current for a light-emitting diode, in practical applications, it has to use resistors 13 as current limiting elements to absorb the power variations which are resulted from the variations of electric properties and to overcome the current variations generated from the differences among light-emitting diodes. Consequentially, it causes additional power loss.

However, either the conventional light-emitting device controlled by constant voltage or by constant current, it needs a supply unit for providing a stable current. Thus, it is an important issue to provide a light-emitting device, which can be driven by a variable power source without additional power loss on current limiting elements, to increase the operation efficiency of power.

### SUMMARY OF THE INVENTION

In view of the foregoing, the present invention provides a light-emitting device driven by a variable power source without additional power loss in current limiting elements to increase the operation efficiency of power.

To achieve the above, a light-emitting device in accordance with the present invention includes a light-emitting diode module, a detecting circuit and a control circuit. The light-emitting diode module receives a variable voltage and includes a plurality of light-emitting diode units in series. The detecting circuit detects a light state of at least one of the light-emitting diode units of the light-emitting diode module and outputs at least a control signal. The control circuit includes a plurality of switch units and at least a control unit. The switch units are connected to each other in series, and each of the switch units is electrically connected to the corresponding light-emitting diode unit. The control unit adjusts the amount and/or the light state of the on-state light-emitting diodes in the corresponding light-emitting diode unit via each of the switch units in accordance with the control signal.

To achieve the above, a light-emitting device in accordance with the present invention includes a light-emitting diode module, a detecting circuit and a control circuit. The light-emitting diode module receives a variable voltage and includes a plurality of light-emitting diode units in series. The detecting circuit detects a light state of at least one of the light-emitting diode units of the light-emitting diode module and outputs at least a control signal. The control circuit includes a plurality of switch units and at least a control unit. The switch units are connected to each other in parallel, and each of the switch units is electrically connected to the corresponding light-emitting diode unit. The control unit adjusts the amount and/or the light state of the on-state light-emitting diodes in the corresponding light-emitting diode unit via each of the switch units in accordance with the control signal.

As mentioned above, the light-emitting device in accordance with the present invention adjusts the amount and/or the light state of the on-state light-emitting diodes in the light-emitting diode module via the control circuit. In comparison with the prior art, the present invention can operate the light-emitting diode module in a default state by changing the amount and/or the light state of the on-state light-emitting diodes so as to become a light-emitting device, which can be driven by a variable power source without additional power loss in current limiting elements and, meanwhile, increase the operation efficiency of power.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic figure of a conventional light-emitting device controlled by constant voltage;

FIG. 1B is a schematic figure of a conventional light-emitting device controlled by constant current;

FIG. 2 is a schematic figure of a light-emitting device of a preferred embodiment of the present invention;

FIG. 3 is a schematic figure of a light-emitting device of a preferred embodiment of the present invention;

FIGS. 4A to 4D are schematics figures of different aspects of the light-emitting device of a preferred embodiment of the present invention; and

FIGS. 5A and 5B are schematics figures of a light-emitting device of a preferred embodiment of the present invention and the alternative-current voltage corresponding to the light-emitting device.

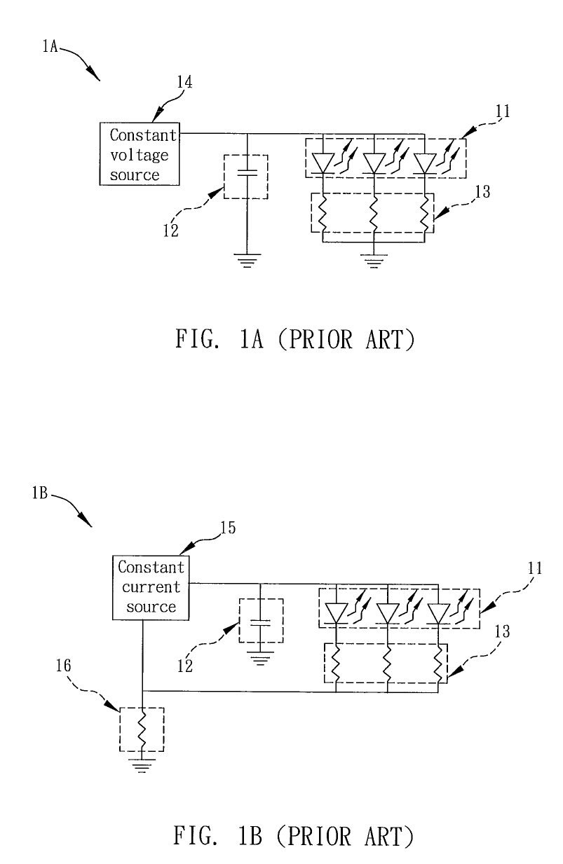

### DETAILED DESCRIPTION OF THE INVENTION

The present invention will be apparent from the following detailed description, which proceeds with reference to the accompanying drawings, wherein the same references relate to the same elements.

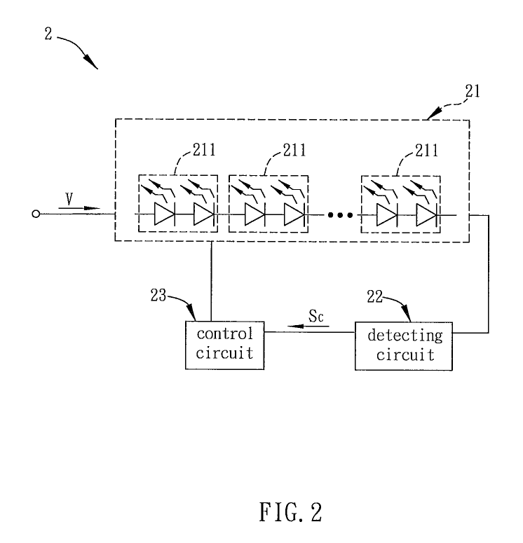

As shown in FIG. 2, FIG. 2 is a schematic figure of a light-emitting device in accordance with a preferred embodiment of the present invention. The light-emitting device 2 includes a light-emitting diode module 21, a detecting circuit 22 and a control circuit 23.

The light-emitting diode module 21 includes a plurality of light-emitting diode units 211 in series, and the light-emitting diode units 211 include at least a light-emitting diode respectively. The light-emitting diode module 21 is used to receive a variable voltage V.

In this embodiment, the variable voltage V can be an alternative-current voltage or a direct-current voltage. The variable voltage V is a voltage, which can change its own level along with the time periodically or randomly, and refers to the inconstant voltage. In more detailed, the aforementioned alternative-current voltage can be the well-known commercial power, which is an alternative current in the range from 90V to 250V, or an alternative current outputted from a power converter. Otherwise, the aforementioned direct-current voltage includes a voltage generated from a battery, a battery jar or an alternative-current voltage via a rectification circuit. However, variations of the outputted voltage levels are generated from the increase of usage period of the battery and the battery jar. And the direct-current voltage generated via the rectification circuit still has nipples. Therefore, in practice, this sort of the direct-current voltage level varies with the time yet.

The detecting circuit 22 detects a light state of the light-emitting diode module 21 and then outputs a control signal S_{C}. In one example, the detecting circuit 22 can include a resistor, a light detector, a photodiode, an induction coil, an electromagnetic induction element or a magnetoelectric induction element. In one example, the means of connecting the detecting circuit 22 to the light-emitting diode module 21 can be used by coupling or by electrical connection in accordance with the selected detecting circuit 22. Additionally, the detecting circuit 22 can be an integrated circuit.

Otherwise, types of the light state of the light-emitting diode module described herein are, for example, the current value, the voltage value, the electric power, the luminous intensity and/or the luminous power of the light-emitting diode module. In other words, in one example, various types of the detecting circuit 22 can be used in accordance with needs of products or practical designs.

The control circuit 23 is electrically connected to the light-emitting diode module 21, and adjusts the amount and/or the light state of the on-state light-emitting diodes in the light-emitting diode module 21 in accordance with the control signal Sc. In one example, the control circuit 23 can be a digital control circuit or an analog control circuit, and at least one of the light-emitting diode units 211 in the light-emitting diode module 21 is not controlled by the control circuit 23. Additionally, in the present embodiment, the control circuit 23 can be an integrated circuit.

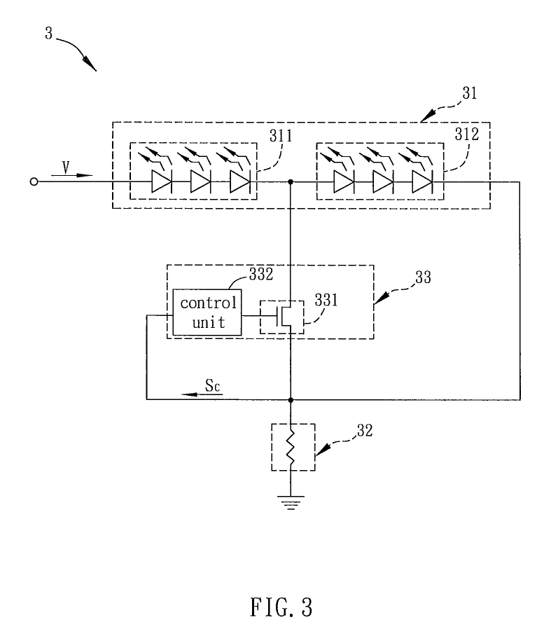

Moreover, as shown in FIG. 3, the light-emitting device of the present invention is further described herein. A light-emitting diode module 31 of a light-emitting device 3 includes a first light-emitting diode unit 311 and a second light-emitting diode unit 312 connected to each other in series. In the present embodiment, the light-emitting diode module 31 receives a variable voltage V to drive the first light-emitting diode unit 311 and the second light-emitting diode unit 312.

Otherwise, in one example, the light-emitting diodes of the first light-emitting diode unit 311 and the second light-emitting diode unit 312 can be connected in series first and then connected in parallel, and/or connected in parallel first and then connected in series.

A detecting circuit 32 is electrically connected to the second light-emitting diode unit 312, and detects the value of the current flowing through the second light-emitting diode unit 312 to generate a control signal Sc. In the present embodiment, the detecting circuit 32 includes a resistor.

A control circuit 33 includes a switch unit 331 and a control unit 332. The switch unit 331 is electrically connected to the second light-emitting diode unit 312. The control unit 322 is electrically connected to the switch unit 331 and the detecting circuit 32, and receives the control signal Sc generated by the detecting circuit 32. In one example, the switch unit includes a bipolar junction transistor (BJT) or a field effect transistor (FET).

In the present embodiment, the control unit 322 controls the switch unit 331 to switch between on-state and off-state by determining whether the control signal Sc is weaker than a default value. Practically, the control circuit 33 can cut off or conduct the second light-emitting diode unit 312 to operate the light-emitting diode module 31 with a default current value in accordance with the control signal Sc.

To be noticed, in the present embodiment, the first light-emitting diode unit 311 is not controlled by the control unit 33, and the detecting circuit 32 is a real-time detecting circuit. Herein, as above mentioned that the first light-emitting diode unit 311 is not controlled by the control unit 33 refers to whether the first light-emitting diode unit 311 emits light is controlled by the power source and, meanwhile, the operation of the control circuit 33 does not influence whether the first light-emitting diode unit 311 emits light. However, the electrical connection still exists between the first light-emitting diode unit 311 and the control unit 33.

In the aforementioned hardware architecture, the present invention can operate the light-emitting diode module in a default state by altering the amount and/or the light state of the on-state light-emitting diodes. Therefore, a power supply of the light-emitting device is not limited to provide a stable current.

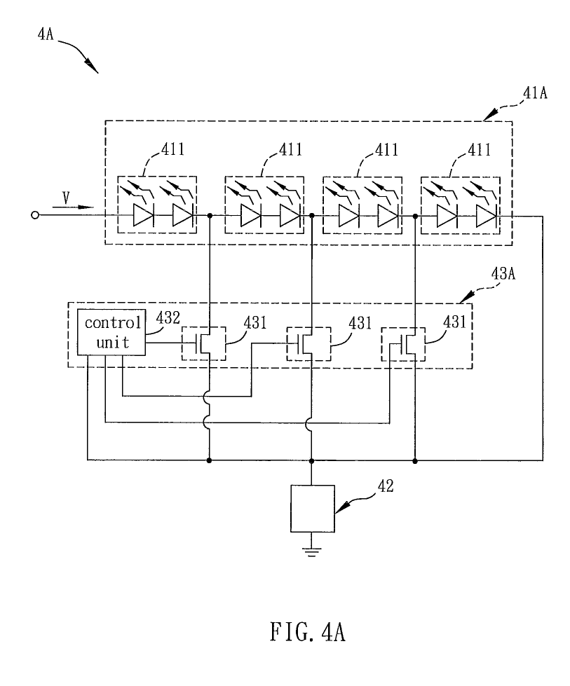

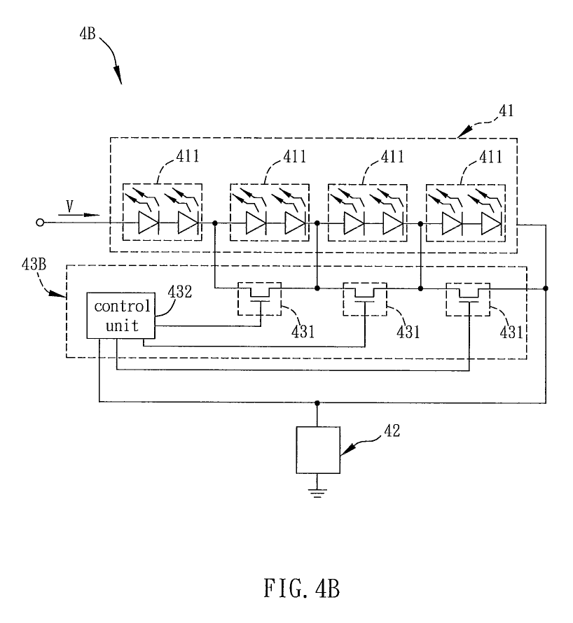

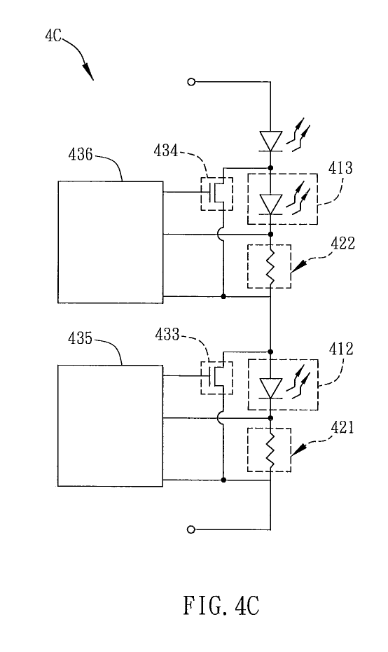

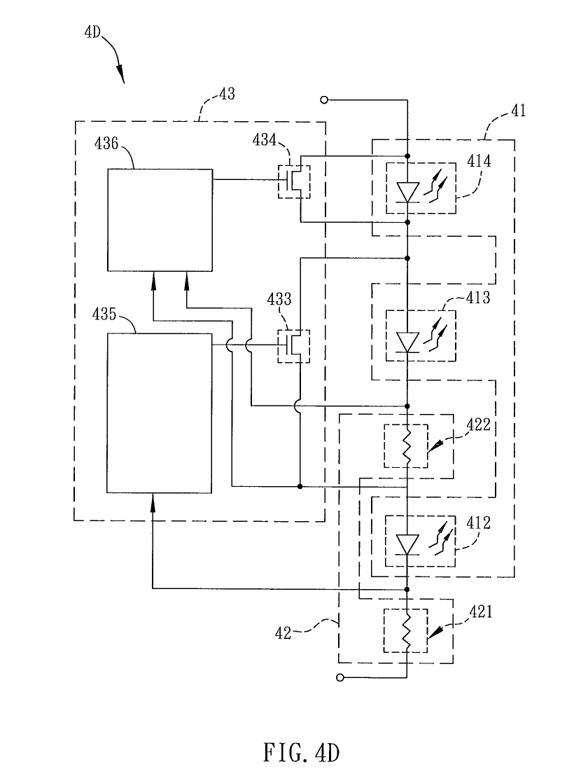

Otherwise, in one example, the architecture between the detecting circuit and the control circuit can be various aspects in accordance with different needs. As shown in FIGS. 4A to 4D, four exemplary application architectures of the detecting circuit and the control circuit are illustrated.

As shown in FIG. 4A, a light-emitting diode module 41 of a light-emitting device 4A includes a plurality of the light-emitting diode units 411 connected in series, and a control circuit 43A includes a plurality of switch units 431 and a control unit 432. Each of the switch units 431 is electrically connected to the corresponding light-emitting diode unit 411, respectively, and each of the switch units 431 is mutually connected in parallel.

In one example, the control unit 432 can include a shifting register and a comparator. The shifting register is electrically connected to each of the switch units 431, respectively. The comparator is electrically connected to the shifting register and the detecting circuit 42, respectively, and receives the control signal generated by the detecting circuit 42. The control circuit 432 can cut off or conduct each of the light-emitting diode units 411 to operate the light-emitting diode module 41 with a default current value by determining whether the control signal is weaker than a default value through the comparator.

Moreover, as shown in FIG. 4B, the difference between the light-emitting devices 4B and 4A is that each of the switch units 431 of a control circuit 43B is mutually connected in series and electrically connected between two light-emitting diode units 411 to control the conduction path of the current.

Additionally, as shown in FIG. 4C, in one non-limiting embodiment, for providing clear illustration, the light-emitting diode module has, for example, three light-emitting diode units.

A light-emitting device 4C includes a first detecting unit 421 and a second detecting unit 422. The first detecting unit 421 is electrically connected to a first light-emitting diode unit 412, and detects the light state of the first light-emitting diode unit 412. The second detecting unit 422 is electrically connected to a second light-emitting diode unit 413, and detects the light state of the second light-emitting diode unit 413.

A control circuit includes a first switch unit 433, a second switch unit 434, a first control unit 435 and a second control unit 436. The first switch unit 433 is electrically connected to the first light-emitting diode unit 412. The first control unit 435 adjusts the amount and/or the light state of the on-state light-emitting diodes in the first light-emitting diode unit 412 in accordance with the light state of the first light-emitting diode unit 412.

Otherwise, the second switch unit 434 is electrically connected to the second light-emitting diode unit 413. The second control unit 436 adjusts the amount and/or the light state of the on-state light-emitting diodes in the second light-emitting diode unit 413 in accordance with the light state of the second light-emitting diode unit 413.

In the present embodiment, the control unit adjusts the amount and/or the light state of the on-state light-emitting diodes in the light-emitting diode units in accordance with the light state of the aforementioned light-emitting diode units detected by the detecting unit. In other words, the control unit adjusts the light-emitting diode unit in accordance with the control signal outputted by the detecting unit in the same group.

As shown in FIG. 4D, a light-emitting diode module of the light-emitting device 4D includes a first light-emitting diode unit 412, a second light-emitting diode unit 413 and a third light-emitting diode unit 414.

A detecting circuit 42 includes a first detecting unit 421 and a second detecting unit 422. The first detecting unit 421 is electrically connected to the first light-emitting diode unit 412, and detects the light state of the first light-emitting diode unit 412. The second detecting unit 422 is electrically connected to the second light-emitting diode unit 413, and detects the light state of the second light-emitting diode unit 413.

A control circuit 43 includes a first switch unit 433, a second switch unit 434, a first control unit 435 and a second control unit 436. In the present embodiment, the first switch unit 433 is electrically connected to the second light-emitting diode unit 413. The first control unit 435 is electrically connected to the first detecting unit 421 and the first switch unit 433, respectively, and adjusts the amount and/or the light state of the on-state light-emitting diodes in the second light-emitting diode unit 413 in accordance with the light state of the first light-emitting diode unit 412.

Moreover, the second switch unit 434 is electrically connected the third light-emitting diode unit 414. The second control unit 436 is electrically connected to the second detecting unit 422 and the second switch unit 434, respectively, and adjusts the amount and/or the light state of the on-state light-emitting diodes in the third light-emitting diode unit 414 in accordance with the light state of the second light-emitting diode unit 413.

Therefore, in the present embodiment, the control unit adjusts the amount and/or the light state of the on-state light-emitting diodes in the light-emitting diode unit in accordance with the light state of another light-emitting diode unit detected by the detecting unit. To be noticed, the another light-emitting diode unit described herein is a light-emitting diode unit connected to the light-emitting diode unit detected by the detecting unit in series directly or indirectly. In other words, the control unit adjusts the light-emitting diode unit in accordance with the control signal outputted by the detecting unit from the previous group.

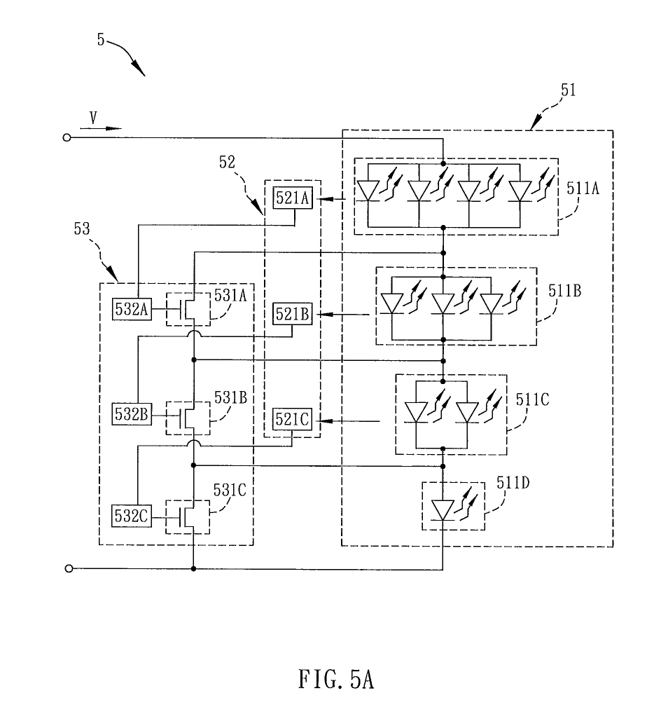

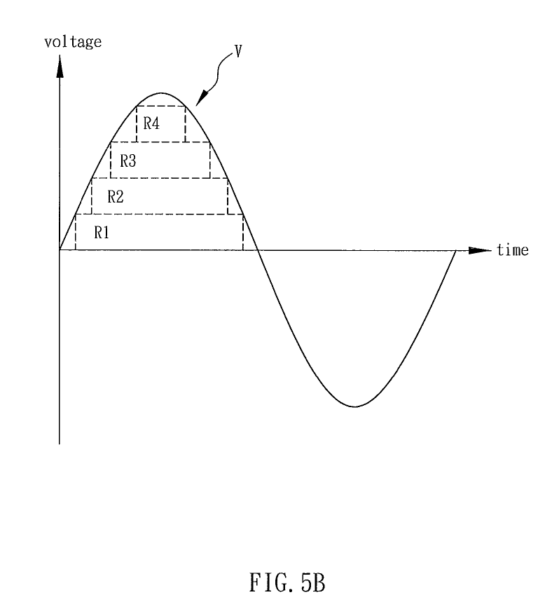

As shown in FIG. 5A and FIG. 5B, a method of adjusting the amount of the light-emitting diodes used while a light-emitting device 5 is operated via alternative-current voltage is further described. Additionally, in the present embodiment, the current flowing through all of the light-emitting diode units is, for example but not limited to, a constant current (80 mA).

As shown in FIG. 5B, in the present embodiment, the variable voltage V is an alternative-current voltage. Furthermore, the variable voltage V can be separated into four divisions from low to high voltage. During the first division R1, the duty of the light-emitting diode module is 85%; during the second division R2, the duty of the light-emitting diode module is 70%; during the third division R3, the duty of the light-emitting diode module is 50%; and during the forth division R4, the duty of the light-emitting diode module is 25%.

As shown in FIG. 5A, a light-emitting diode module 51 of the light-emitting device 5 includes four light-emitting diode units 511A, 511B, 511C and 511D mutually connected in series. The light-emitting diode units 511A, 511B and 511C respectively include four, three and two light-emitting diodes connected in parallel.

The control circuit 53 includes a first switch unit 531A, a second switch unit 531B, a third switch unit 531C, a first control unit 532A, a second control unit 532B and the third control unit 532C. Each of the switch units 531A to 531C, is electrically connected to the corresponding light-emitting diode units 511A to 511D, respectively, and each of the switch units 531A to 531C is mutually connected in series.

The detecting circuit 52 includes a first detecting unit 521A, a second detecting unit 521B and a third detecting unit 521C. Each of the detecting units (the first detecting unit 521A, the second detecting unit 521B and the third detecting unit 521C) is coupled with the light-emitting diode units 511A to 511C, respectively, and electrically connected to the control units (the first control unit 532A, the second control unit 532B and the third control unit 532C), respectively, to detect variations of the voltage level of the variable voltage V.

During the voltage level of the variable voltage V is in the first division R1, the light-emitting diode unit 511A emits light in accordance with the received variable voltage V; during the voltage level of the variable voltage V is in the second division R2, the first detecting unit 521A outputs the control signal to the first control unit 532A to cut off the first switch unit 531A so as to conduct the light-emitting diode units 511A and 511B; during the voltage level of the variable voltage V is in the third division R3, the first detecting unit 521A and the second detecting unit 521B output the control signals to the first control unit 532A and the second control unit 532B respectively to cut off the first switch unit 531A and the second switch unit 531B so as to conduct the light-emitting diode units 511A to 511C; and during the voltage level of the variable voltage V is in the forth division R4, each of the detecting unit 521A to 521C outputs the control signal to each of the control units 532A to 532C respectively to cut off the first switch unit 531A, the second switch unit 531B and the third switch unit 531C so as to conduct the light-emitting diode units 511A to 511D.

In other words, during the voltage level is in the first division R1, the current flowing through each of the light-emitting diodes of the light-emitting diode unit 511A is 20 mA; during the voltage level is in the second division R2, one added current flowing through each of the light-emitting diodes of the light-emitting diode unit 511B is 26.6 mA; during the voltage level is in the third division R3, another added current flowing through each of the light-emitting diodes of the light-emitting diode unit 511C is 40 mA; and during the voltage level is in the forth division R4, the other added current flowing through the light-emitting diodes of the light-emitting diode unit 511D is 80 mA. Meanwhile, the ratio of the output power among the light-emitting diode units 511A to 511D is 17:18.62:20:20.

In one example, the light-emitting device can further include a capacitor or adjust the amount of the light-emitting diodes connected in series in each of the light-emitting diode units in order to extend the duties of the first division and second division. It results in the relative ratio of the duty of each division being 100%, 75%, 50% and 25%, and then causes the output power ratio of each of the light-emitting diode units becoming 20:20:20:20.

In the hardware architecture as shown in FIG. 5A, the present invention can enable each of the light-emitting diode units to have similar or identical output powers by changing the amount of the on-state light-emitting diodes in each of the light-emitting diode units.

Moreover, it is also possible for the detecting units 521A to 521C to detect the average light power of the light-emitting diode units 511A to 511C and outputs a control signal to each of the control units 532A to 532C respectively to control the switch unit 531A to 531C so as to control the outputting light power of the light-emitting diode units 511A to 511C, and to keep the total outputting light power of the light-emitting diode module 51 at a controlled and limited level.

Moreover, it is worth mentioning that the amount of the light-emitting diodes used in each of the light-emitting diode units is not limited in accordance with the present invention. And, at least one of the light-emitting diode units is not controlled by the control circuit. In addition, the light-emitting device of the present invention can be used as a backlight source or a lighting device, and applied to fields like mobile communication, transportation lighting and general lighting as well.

In summary, the light-emitting device of the present invention can adjust the amount and/or the light state of the on-state light-emitting diodes in a light-emitting diode module by a control circuit. In comparison with the prior art, the present invention can operate the light-emitting diode module in a default state by changing the amount and/or the light state of the on-state light-emitting diodes so as to become a light-emitting device, which can be driven by a variable power source without additional power loss in current limiting elements and, meanwhile, increase the operation efficiency of power.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting device, comprising:
a light-emitting diode module receiving a variable voltage and comprising a plurality of light-emitting diode units in series;
a detecting circuit detecting a light state of at least one of the light-emitting diode units of the light-emitting diode module and outputting at least a control signal; and
a control circuit comprising a plurality of switch units and at least a control unit, wherein the switch units are connected to each other in series, each of the switch units is electrically connected to the corresponding light-emitting diode unit, and the control unit adjusts the amount and/or the light state of the on-state light-emitting diodes in the corresponding light-emitting diode unit via each of the switch units in accordance with the control signal.

2. The light-emitting device of claim 1, wherein the variable voltage is an alternative-current voltage or a direct-current voltage.

3. The light-emitting device of claim 2, wherein the direct-current voltage is generated from the alternative-current voltage via a rectification circuit.

4. The light-emitting device of claim 1, wherein the light state of the light-emitting diode unit is a current value, a voltage value, an electric power or a luminous power of the light-emitting diode unit.

5. The light-emitting device of claim 1, wherein the detecting circuit comprises a resistor or a light detector.

6. The light-emitting device of claim 1, wherein the control circuit is a digital control circuit or an analog control circuit.

7. The light-emitting device of claim 1, wherein the detecting circuit and/or the control circuit is an integrated circuit.

8. The light-emitting device of claim 1, wherein at least one of the light-emitting diode units comprises a plurality of light-emitting diodes connected to each other in parallel.

9. The light-emitting device of claim 1, wherein at least one of the light-emitting diode units is not controlled by the control circuit.

10. The light-emitting device of claim 1, wherein the detecting circuit comprises a plurality of detecting units, and each of the detecting units detects the light state of the corresponding light-emitting diode unit.

11. A light-emitting device, comprising:
a light-emitting diode module receiving a variable voltage and comprising a plurality of light-emitting diode units in series;
a detecting circuit detecting a light state of at least one of the light-emitting diode units of the light-emitting diode module and outputting at least a control signal; and
a control circuit comprising a plurality of switch units and at least a control unit, wherein the switch units are connected to each other in parallel, each of the switch units is electrically connected to the corresponding light-emitting diode unit, and the control unit adjusts the amount and/or the light state of the on-state light-emitting diodes in the corresponding light-emitting diode unit via each of the switch units in accordance with the control signal.

12. The light-emitting device of claim 11, wherein the variable voltage is an alternative-current voltage or a direct-current voltage.

13. The light-emitting device of claim 12, wherein the direct-current voltage is generated from the alternative-current voltage via a rectification circuit.

14. The light-emitting device of claim 11, wherein the light state of the light-emitting diode unit is a current value, a voltage value, an electric power or a luminous power of the light-emitting diode unit.

15. The light-emitting device of claim 11, wherein the detecting circuit comprises a resistor or a light detector.

16. The light-emitting device of claim 11, wherein the control circuit is a digital control circuit or an analog control circuit.

17. The light-emitting device of claim 11, wherein the detecting circuit and/or the control circuit is an integrated circuit.

18. The light-emitting device of claim 11, wherein at least one of the light-emitting diode units comprises a plurality of light-emitting diodes connected to each other in parallel.

19. The light-emitting device of claim 11, wherein at least one of the light-emitting diode units is not controlled by the control circuit.

20. The light-emitting device of claim 11, wherein the detecting circuit comprises a plurality of detecting units, and each of the detecting units detects the light state of the corresponding light-emitting diode unit.
